(19) United States
(12) Patent Application Publication
(10) Pub. No.: US 2026/0328128 A1
(43) Pub. Date: Oct. 22, 2026

(54) EXHAUST PRESSURE ESTIMATION METHOD, EXHAUST PRESSURE ESTIMATION DEVICE, AND CONTROL METHOD FOR INTERNAL COMBUSTION ENGINE

(71) Applicant: NISSAN MOTOR CO., LTD., Yokohama-shi (JP)

(72) Inventor: Taichi ANDO, Kanagawa (JP)

(73) Assignee: NISSAN MOTOR CO., LTD., Yokohama-shi (JP)

(21) Appl. No.: 19/654,037

(22) Filed: Apr. 21, 2026

(30) Foreign Application Priority Data
Apr. 22, 2025 (JP) 2025-70099

(51) Int. Cl. F01N 11/00; F01N 3/021; F02M 26/00; F02M 26/02; F02M 26/22

(52) U.S. Cl. CPC F01N 11/005; F01N 3/021; F02M 26/02; F02M 26/22; F02M 2026/004

(57) ABSTRACT

For an internal combustion engine including an exhaust passage provided with an exhaust particulate filter and an EGR system, an exhaust pressure within the exhaust passage is calculated based on a flow rate of exhaust gas passing through the exhaust particulate filter. An EGR valve is controlled by: calculating a first pressure on an exhaust passage side of the EGR valve based on the calculated exhaust pressure; calculating a target opening area of the EGR valve required for achievement of a target EGR gas quantity, based on: the target EGR gas quantity; the calculated first pressure; a second pressure on an intake passage side of the EGR valve; a temperature of EGR gas passing through the EGR valve; and controlling the EGR valve based on the calculated target opening area.

### BACKGROUND

The present disclosure relates to an exhaust pressure estimation method, an exhaust pressure estimation device, and a control method for an internal combustion engine.

Japanese Patent Application Publication No. 2012-21433 (JP 2012-21433 A) discloses a technique for accurately estimating a flow rate of EGR (Exhaust Gas Recirculation) gas passing through an EGR valve disposed in an EGR pipe, based on an average value of an upstream pressure and an average of a downstream pressure with respect to the EGR valve. The upstream pressure is measured by an EGR valve upstream pressure sensor, and the downstream pressure is measured by an intake pipe internal pressure sensor disposed in an intake passage.

### SUMMARY

However, the EGR valve upstream pressure sensor disclosed in JP 2012-21433 A is located in an exhaust section immediately upstream of the EGR valve. This requires consideration of heat resistance, which may result in an increase in manufacturing cost.

In view of the foregoing, it is desirable to provide a system for accurately estimating a pressure upstream of an EGR valve with no increase in manufacturing cost.

According to one aspect of the present disclosure, an exhaust pressure estimation method for an internal combustion engine including an exhaust passage provided with an exhaust particulate filter for capturing exhaust particulates, the exhaust pressure estimation method includes: calculating by a controller an exhaust pressure within the exhaust passage based on a flow rate of exhaust gas passing through the exhaust particulate filter.

According to another aspect of the present disclosure, a control method for an internal combustion engine, wherein the internal combustion engine includes: an intake passage; an exhaust passage provided with an exhaust particulate filter for capturing exhaust particulates; an exhaust gas recirculation passage having a first end connected to the exhaust passage, and a second end connected to the intake passage; and an exhaust gas recirculation valve disposed in the exhaust gas recirculation passage, the control method includes: calculating an exhaust pressure within the exhaust passage based on a flow rate of exhaust gas passing through the exhaust particulate filter; calculating a first pressure on an exhaust passage side of the exhaust gas recirculation valve based on the calculated exhaust pressure; calculating a target opening area of the exhaust gas recirculation valve required for achievement of a target exhaust gas recirculation gas quantity, based on: the target exhaust gas recirculation gas quantity; the calculated first pressure; a second pressure on an intake passage side of the exhaust gas recirculation valve; a temperature of exhaust gas recirculation gas passing through the exhaust gas recirculation valve; and controlling the exhaust gas recirculation valve based on the calculated target opening area.

According to a further aspect of the present disclosure, an exhaust pressure estimation device for an internal combustion engine, includes: an exhaust passage provided with an exhaust particulate filter for capturing exhaust particulates; and a controller configured to calculate an exhaust pressure within the exhaust passage based on a flow rate of exhaust gas passing through the exhaust particulate filter.

### BRIEF DESCRIPTION OF THE DRAWINGS

FIG. 1 is an explanatory diagram schematically showing a configuration of an internal combustion engine system according to a first embodiment of the present disclosure.

FIG. 2 is a block diagram showing a process for calculating a target EGR valve opening degree.

FIG. 3 is an explanatory diagram schematically showing a configuration of an internal combustion engine system according to a second embodiment of the present disclosure.

FIG. 4 is an explanatory diagram schematically showing a configuration of a main section of an internal combustion engine system according to another embodiment of the present disclosure.

### DETAILED DESCRIPTION

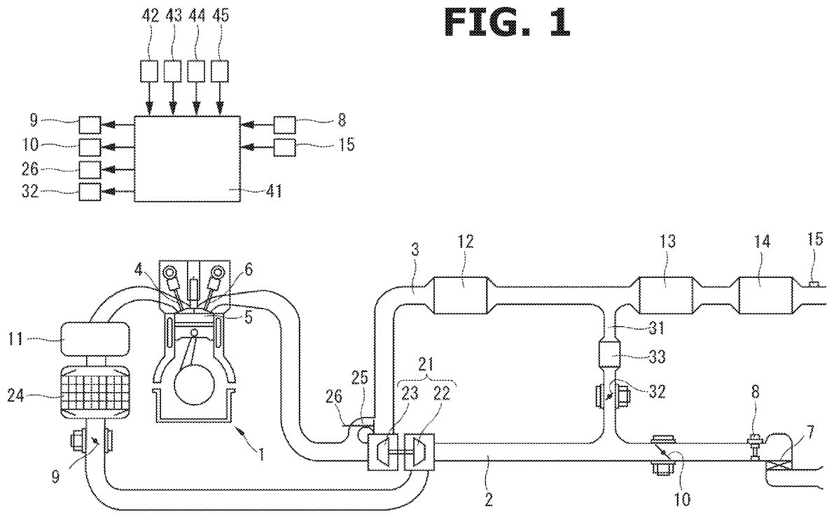

FIG. 1 schematically shows a system configuration of an internal combustion engine 1 according to a first embodiment of the present disclosure.

The internal combustion engine 1 is mounted as a driving source on a vehicle such as an automobile. The internal combustion engine 1 has an intake passage 2 and an exhaust passage 3. The intake passage 2 is connected to combustion chambers 5 via intake valves 4. The exhaust passage 3 is connected to the combustion chambers 5 via exhaust valves 6. The internal combustion engine 1 may be of either a direct injection type or a port injection type.

The intake passage 2 is provided with: an air cleaner 7 for collecting foreign matter contained in intake air; an air flow meter 8 for measuring a quantity of intake air; a first throttle valve 9 of an electric type; a second throttle valve 10 of an electric type, which is located upstream of the first throttle valve 9 in a direction of flow of intake air; and an intake collector 11 for distributing intake air to intake ports of cylinders of the internal combustion engine 1.

In the following description, terms “upstream” and “downstream” are defined with respect to the direction of flow of intake air in the intake passage 2, a direction of flow of exhaust gas in the exhaust passage 3, and a direction of flow of EGR gas in an EGR passage 31 detailed below.

The air cleaner 7 is located upstream of the air flow meter 8. The air flow meter 8 is located upstream of the second throttle valve 10. The air flow meter 8 contains a temperature sensor, and is structured to measure a temperature of intake air in the intake passage 2.

The first throttle valve 9 regulates a quantity of intake air entering the internal combustion engine 1, in accordance with an engine load. The second throttle valve 10 regulates an intake pressure upstream of a compressor 22 detailed below.

The opening of the first throttle valve 9 and the opening of the second throttle valve 10 are controlled by control signals from a control unit 41 detailed below.

The exhaust passage 3 is provided with a first catalytic converter 12, a GPF (Gasoline Particulate Filter) 13 as an exhaust particulate filter, a second catalytic converter 14, and an exhaust gas temperature sensor 15.

The GPF 13 is located downstream of the first catalytic converter 12 and upstream of the second catalytic converter 14. The second catalytic converter 14 is located downstream of the GPF 13. The exhaust gas temperature sensor 15 is located downstream of the second catalytic converter 14.

The first catalytic converter 12 and the second catalytic converter 14 are exhaust purification catalytic converters, such as three-way catalytic converters, for purifying NOx, HC, and CO contained in exhaust gas. The GPF 13 is capable of capturing PM (Particulate Matter) contained in exhaust gas, and burning the PM for regeneration of the GPF 13. The exhaust gas temperature sensor 15 is capable of measuring an exhaust gas temperature in a section of the exhaust passage 3 downstream of the second catalytic converter 14.

The internal combustion engine 1 is provided with a turbocharger or turbo supercharger 21. The turbocharger 21 has the compressor 22 disposed in the intake passage 2, and a turbine 23 disposed in the exhaust passage 3. The compressor 22 and the turbine 23 are arranged coaxially and rotate as a solid unit. The compressor 22 is located upstream of the first throttle valve 9 and downstream of the second throttle valve 10. The turbine 23 is located upstream of the first catalytic converter 12.

The intake passage 2 is provided with an intercooler 24 downstream of the first throttle valve 9. The intercooler 24 cools the intake air compressed or pressurized by the compressor 22, and thereby enhances charging efficiency.

The exhaust passage 3 is provided with an exhaust bypass passage 25 that bypasses the turbine 23 and connects an upstream side and a downstream side of the turbine 23. The exhaust bypass passage 25 has a downstream end connected to a section of the exhaust passage 3 upstream of the first catalytic converter 12. The exhaust bypass passage 25 is provided with an electric wastegate valve 26 for regulating a flow rate of exhaust gas within the exhaust bypass passage 25. The opening of the wastegate valve 26 is controlled by a control signal from the control unit 41 detailed below.

The internal combustion engine 1 is also capable of exhaust gas recirculation (EGR) by which a portion of exhaust gas is introduced or recirculated as EGR gas from the exhaust passage 3 into the intake passage 2. The internal combustion engine 1 is provided with the EGR passage 31 that has a first end connected to the exhaust passage 3 and a second end connected to the intake passage 2. The first end of the EGR passage 31 is connected to a section of the exhaust passage 3 between the first catalytic converter 12 and the GPF 13, whereas the second end of the EGR passage 31 is connected to a section of the intake passage 2 downstream of the second throttle valve 10 and upstream of the compressor 22. The EGR passage 31 is provided with an electric EGR valve 32 for adjusting or regulating the flow rate of EGR gas within the EGR passage 31, and an EGR cooler 33 for cooling the EGR gas. The opening of the EGR valve 32 is controlled by a control signal from the control unit 41 detailed below. The EGR cooler 33 is located upstream of the EGR valve 32, namely, located closer to the exhaust passage 3 than the EGR valve 32.

The control unit 41 is a well-known digital computer equipped with a CPU, ROM, RAM, and input/output interfaces. The control unit 41 receives input of sensing signals (measured values) from the air flow meter 8 and the exhaust gas temperature sensor 15, and also receives input of sensing signals (measured values) from various sensors which include: a crank angle sensor 42 for measuring a crank angle of a crankshaft not shown of the internal combustion engine 1; an accelerator opening sensor 43 for measuring an amount of depression of an accelerator pedal (i.e. accelerator opening APO) which indicates a state of a required load of the internal combustion engine 1; a water temperature sensor 44; and an atmospheric pressure sensor 45 for measuring atmospheric pressure.

The water temperature sensor 44 measures a temperature of a coolant for the internal combustion engine 1. In this embodiment, values measured by the water temperature sensor 44 are regarded and used as values of a temperature of a coolant supplied to the EGR cooler 33.

The control unit 41 is capable of calculating the engine speed of the internal combustion engine 1 based on the sensing signal from the crank angle sensor 42.

The control unit 41 is capable of calculating the required load (engine load) of the internal combustion engine 1 based on the sensing signal from the accelerator position sensor 43.

Furthermore, based on the sensing signals from the various sensors, the control unit 41 optimally controls the fuel injection quantity, fuel injection timing, ignition timing, opening of the first throttle valve 9, opening of the second throttle valve 10, opening of the wastegate valve 26, opening of the EGR valve 32, etc. of the internal combustion engine 1.

According to the first embodiment, the second end of the EGR passage 31 is connected to a section of the intake passage 2 between the first throttle valve 9 and the second throttle valve 10, wherein a negative pressure occurring at this section is controlled by the second throttle valve 10. Accordingly, in the first embodiment, the second throttle valve 10 serves as a negative pressure generating valve for regulating the pressure on the intake passage side of the EGR valve 32.

The control unit 41 serves as an estimation section to calculate an EGR system upstream pressure, which is a pressure in the exhaust passage 3 at a location where the first end of the EGR passage 31 is connected, based on a GPF-passing exhaust gas flow rate that is a flow rate of exhaust gas passing through the GPF 13.

Conventionally, in an internal combustion engine system with a GPF in an exhaust passage, a flow rate of exhaust gas passing through the GPF is calculated, for example, based on a differential pressure across the GPF, an intake air quantity, etc. The thus calculated GPF-passing exhaust flow rate is used to calculate the EGR system upstream pressure. The calculation or estimation of the GPF-passing exhaust flow rate is implemented by a publicly known method with no additional pressure sensor. For example, the EGR system upstream pressure is calculated based on: the atmospheric pressure; the temperature of exhaust gas passing through the exhaust passage 3; the opening area of the exhaust passage 3, which corresponds to the passage resistance of the entire exhaust passage 3, which is an exhaust system including the GPF 13; and the flow rate of exhaust passage gas discharged from the exhaust passage 3 to the outside.

In the first embodiment, the first end of the EGR passage 31 is connected to a section of the exhaust passage 3 upstream of the GPF 13, so that the GPF-passing exhaust flow rate is equal to the flow rate of exhaust gas discharged from the exhaust passage 3 to the outside.

For example, the temperature of the exhaust gas passing through the exhaust passage 3 is determined based on a value measured by the exhaust gas temperature sensor 15.

Alternatively, the temperature of the exhaust gas passing through the exhaust passage 3 may be estimated, for example, based on the operating state of the internal combustion engine 1.

Furthermore, the control unit 41 serves as a control section to calculate a target opening area of the EGR valve 32 (target EGR valve opening area) based on: an EGR valve upstream pressure, which is a pressure on the exhaust passage side (upstream side) of the EGR valve 32 in the EGR passage 31 and is calculated based on the EGR system upstream pressure; an EGR valve downstream pressure, which is a pressure on the intake passage side (downstream side) of the EGR valve 32 in the EGR passage 31; an EGR cooler downstream side EGR gas temperature, which is a temperature of EGR gas passing through the EGR valve 32; and a target quantity of EGR gas passing through the EGR valve 32. The target EGR gas quantity is calculated depending on the operating state of the internal combustion engine 1. The target EGR valve opening area is a target value of the opening area of the EGR valve 32 required to achieve the target EGR gas quantity.

For example, the target EGR valve opening area is calculated using equations (1) to (3).

$$A = \frac{\sqrt{T}}{{P}_{us}} * \frac{{f}_{2 ( κ , R , {P}_{ds} / {P}_{us} )}}{{f}_{1 ( κ , R )}} * m \qquad ( 1 )$$

$${f}_{1 ( κ , R )} = \sqrt{\frac{κ}{R} {( \frac{2}{κ + 1} )}^{\frac{κ + 1}{κ - 1}}} \qquad ( 2 )$$

$${f}_{2 ( κ , R , \frac{{P}_{ds}}{{P}_{ds}} )} = {( \frac{2}{κ + 1} )}^{- \frac{1}{κ}} \sqrt{\frac{κ + 1}{κ - 1} ( 1 - {( \frac{{P}_{ds}}{{P}_{us}} )}^{\frac{κ + 1}{κ + 1}} )} \qquad ( 3 )$$

In the above equations, A represents an opening area, e.g., the target EGR valve opening area. T represents a gas temperature, e.g., the EGR cooler downstream side EGR gas temperature. m represents a mass flow rate, e.g., the target EGR gas quantity. Pus represents an upstream pressure of a target object, e.g., the upstream pressure of the EGR valve. Pds represents a downstream pressure of the target object, e.g., the downstream pressure of the EGR valve. R represents a so-called gas constant. In the above formula, k is a specific heat ratio, which is a ratio of a specific heat capacity at constant pressure to a specific heat capacity at constant volume.

For example, the temperature of the EGR gas passing through the EGR valve 32 is determined based on a value measured by the exhaust gas temperature sensor 15. The temperature of the EGR gas passing through the EGR valve 32 may also be estimated, for example, based on the operating state of the internal combustion engine 1.

The EGR valve upstream pressure is calculated based on: the EGR system upstream pressure; the temperature of the EGR gas passing through the EGR valve 32; the temperature of the exhaust gas passing through the exhaust passage 3; the opening area of the EGR passage 31, which corresponds to an airflow resistance of the EGR cooler 33; and the target EGR gas quantity. The EGR valve upstream pressure is a pressure in the EGR passage 31 on the exhaust passage side of the EGR valve 32.

The EGR valve downstream pressure is calculated based on a target pressure downstream of the second throttle valve 10, i.e., a target value of the negative pressure generated by the second throttle valve 10. For example, the target pressure downstream of the second throttle valve 10 is calculated depending on the operating state of the internal combustion engine 1.

Furthermore, the control unit 41 calculates a target EGR valve opening degree, which is a target opening degree of the EGR valve 32 required to achieve the target EGR gas quantity, based on the target EGR valve opening area.

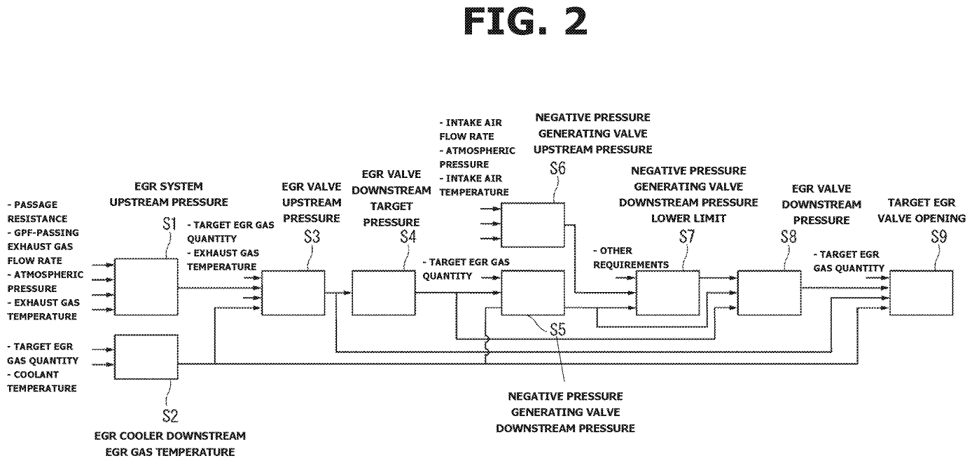

FIG. 2 shows a process for calculating the target EGR valve opening degree.

At Step S1, the EGR system upstream pressure is calculated based on the GPF-passing exhaust gas flow rate, the atmospheric pressure, the exhaust gas temperature, and the passage resistance of the exhaust passage 3. The EGR system upstream pressure calculated at Step S1 is an estimated value.

At Step S2, the temperature of EGR gas downstream of the EGR cooler 33 (EGR cooler downstream side EGR gas temperature) is calculated based on the target EGR gas quantity and coolant temperature. The EGR cooler downstream side EGR gas temperature calculated at Step S2 is an estimated value.

At Step S3, the EGR valve upstream pressure is calculated based on the target EGR gas quantity, the exhaust gas temperature, the EGR system upstream pressure calculated at Step S1, and the EGR cooler downstream side EGR gas temperature calculated at Step S2. The EGR valve upstream pressure calculated at Step S3 is an estimated value.

At Step S4, an EGR valve downstream side target pressure is calculated based on the EGR valve upstream pressure calculated at Step S3.

At Step S5, a negative pressure generation valve downstream pressure is calculated based on the target EGR gas quantity, the EGR cooler downstream side EGR gas temperature calculated at Step S2, and the EGR valve downstream side target pressure calculated at Step S4. For example, the negative pressure generation valve downstream pressure calculated at Step S5 is set to a target value of pressure on the downstream side of the second throttle valve 10.

At Step S6, a negative pressure generation valve upstream pressure is calculated based on the intake air flow rate, atmospheric pressure, and intake air temperature. For example, the negative pressure generation valve upstream pressure calculated at Step S6 is set to an estimated value of pressure upstream of the second throttle valve 10.

At Step S7, a lower limit of the negative pressure generation valve downstream pressure is calculated based on the negative pressure generation valve downstream pressure calculated at Step S5, the negative pressure generation valve upstream pressure calculated at Step S6, and other predetermined requirements. The lower limit of the negative pressure generation valve downstream pressure calculated at Step S7 is a lower limit of pressure at which combustion of the internal combustion engine 1 can be carried out or ensured, for example, a lower limit of pressure downstream of the second throttle valve 10 at which combustion of the internal combustion engine 1 can be carried out or ensured.

At Step S8, the EGR valve downstream pressure is calculated based on the target EGR valve downstream pressure calculated at Step S4, the negative pressure generation valve downstream pressure calculated at Step S5, and the negative pressure generation valve downstream lower limit pressure calculated at Step S7. The EGR valve downstream pressure calculated at Step S8 is an estimated value of pressure downstream of the EGR valve 32.

At Step S9, the target EGR valve opening degree is calculated based on the target EGR gas quantity, the EGR cooler downstream side EGR gas temperature calculated at Step S2, the EGR valve upstream pressure calculated at Step S3, and the EGR valve downstream pressure calculated at Step S8.

Since the internal combustion engine 1 according to the first embodiment described above is provided with the GPF 13 in the exhaust passage 3, the internal combustion engine system includes calculation of the GPF passing exhaust flow rate, which is a flow rate of exhaust gas passing through the GPF 13.

Therefore, the internal combustion engine system provided with the GPF 13 in the exhaust passage 3 can be configured to calculate or estimate the exhaust pressure in the exhaust passage 3 upstream of the EGR valve 32 based on the calculated GPF-passing exhaust flow rate without addition of a separate pressure sensor. In other words, the internal combustion engine system can calculate or estimate the exhaust pressure in the exhaust passage 3 at the position where the EGR passage 31 is connected, without addition of a separate pressure sensor and without incurring any increase in manufacturing cost.

Furthermore, the internal combustion engine system can use the calculated GPF-passing exhaust flow rate to calculate the target EGR valve opening degree for achieving the target EGR gas quantity, which is a required quantity of EGR gas, and control the EGR valve 32 to achieve this target EGR valve opening degree.

The following describes other embodiments of the present disclosure. The same components as those in the first embodiment are designated by the same reference numerals, and redundant description thereof is omitted.

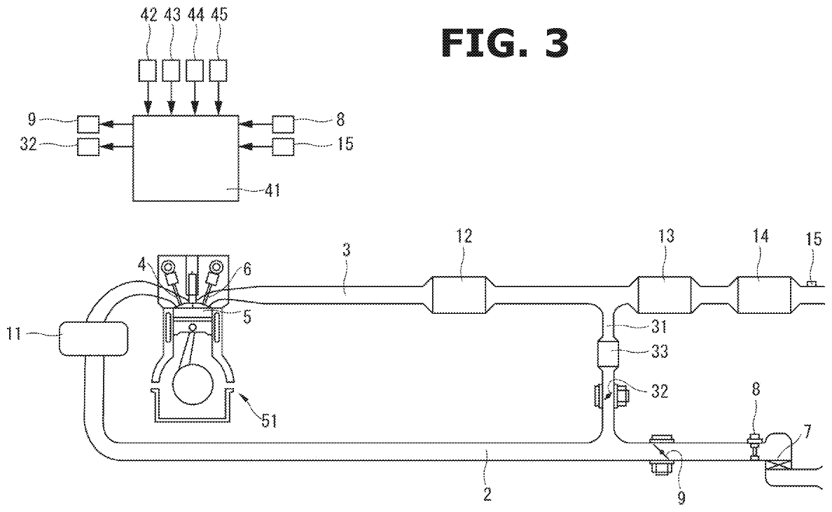

The following describes a second embodiment of the present disclosure with reference to FIG. 3. FIG. 3 schematically shows a configuration of an internal combustion engine system including an internal combustion engine 51 according to the second embodiment of the present disclosure. The internal combustion engine 51 has substantially the same configuration as the internal combustion engine 1 according to the first embodiment. However, as shown in FIG. 3, the internal combustion engine 51 is a naturally aspirated internal combustion engine with no turbocharger 21 and no intercooler 24. Furthermore, in the second embodiment, the intake passage 2 is not provided with the second throttle valve 10, although the intake passage 2 is provided with the first throttle valve 9 for regulating the intake air quantity.

The second end of the EGR passage 31 is connected to a section of the intake passage 2 downstream of the first throttle valve 9. In the internal combustion engine 51, the first throttle valve 9 serves as a negative pressure generating valve. In the second embodiment, the pressure on the intake passage side of the EGR valve 32 is calculated based on the target pressure downstream of the first throttle valve 9.

In the second embodiment, the EGR valve downstream pressure is calculated based on the target pressure downstream of the first throttle valve 9, i.e. a target value of the negative pressure generated by the first throttle valve 9. For example, the target pressure downstream of the first throttle valve 9 is calculated depending on the operating state of the internal combustion engine 51.

The target pressure downstream of the first throttle valve 9 corresponds to the target opening degree of the first throttle valve 9. Association of the target pressure downstream of the first throttle valve 9 with the target opening degree of the first throttle valve 9 makes it possible to calculate the target pressure downstream of the first throttle valve 9 based on a target value of the opening degree of the first throttle valve 9.

Also in the second embodiment, as in the first embodiment, the exhaust pressure in the exhaust passage 3 at the location where the EGR passage 31 is connected can be estimated using the equations (1) to (3) without addition of a separate pressure sensor and without an increasing in manufacturing cost.

Furthermore, also in the second embodiment, the target EGR valve opening degree for achievement of the target EGR gas quantity, which is the required EGR gas quantity, can be calculated based on the GPF-passing exhaust flow rate by the process shown in FIG. 2, so that the EGR valve 32 can be controlled to achieve this target EGR valve opening degree.

Although specific embodiments of the present disclosure have been described above, the present disclosure is not limited to those embodiments, and various modifications are possible without departing from the scope of the present disclosure.

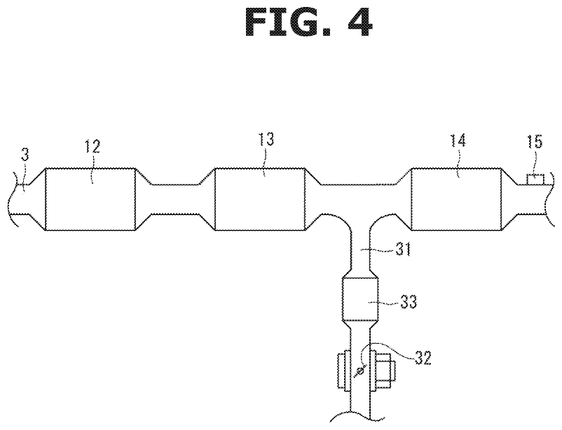

For example, the first end of the EGR passage 31 may be connected to a section of the exhaust passage 3 downstream of the GPF 13, as shown in FIG. 4. In this configuration, the flow rate of exhaust gas discharged from the exhaust passage 3 to the outside is a value obtained by subtracting the target EGR gas quantity from the GPF-passing exhaust flow rate.

The entire contents of Japanese Patent Application 2025-070099 filed Apr. 22, 2025 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

1. An exhaust pressure estimation method for an internal combustion engine including an exhaust passage provided with an exhaust particulate filter for capturing exhaust particulates, the exhaust pressure estimation method comprising:
calculating by a controller an exhaust pressure within the exhaust passage based on a flow rate of exhaust gas passing through the exhaust particulate filter.

2. A control method for an internal combustion engine, wherein the internal combustion engine includes: an intake passage; an exhaust passage provided with an exhaust particulate filter for capturing exhaust particulates; an exhaust gas recirculation passage having a first end connected to the exhaust passage, and a second end connected to the intake passage; and an exhaust gas recirculation valve disposed in the exhaust gas recirculation passage, the control method comprising:
calculating an exhaust pressure within the exhaust passage based on a flow rate of exhaust gas passing through the exhaust particulate filter;
calculating a first pressure on an exhaust passage side of the exhaust gas recirculation valve based on the calculated exhaust pressure;
calculating a target opening area of the exhaust gas recirculation valve required for achievement of a target exhaust gas recirculation gas quantity, based on:
the target exhaust gas recirculation gas quantity;
the calculated first pressure;
a second pressure on an intake passage side of the exhaust gas recirculation valve;
a temperature of exhaust gas recirculation gas passing through the exhaust gas recirculation valve; and
controlling the exhaust gas recirculation valve based on the calculated target opening area.

3. The control method as claimed in claim 2, further comprising:
calculating a target degree of opening of the exhaust gas recirculation valve based on the calculated target opening area; and
controlling the exhaust gas recirculation valve based on the calculated target degree of opening.

4. The control method as claimed in claim 2, wherein the intake passage is provided with a supercharger for compressing intake air, a first throttle valve located downstream of the supercharger, and a second throttle valve located upstream of the supercharger, and wherein the second end of the exhaust gas recirculation passage is connected to a section of the intake passage between the supercharger and the second throttle valve, the control method further comprising:
calculating the second pressure based on a target pressure downstream of the second throttle valve.

5. The control method as claimed in claim 2, wherein the intake passage is provided with a first throttle valve, and wherein the second end of the exhaust gas recirculation passage is connected to a section of the intake passage downstream of the first throttle valve, the control method further comprising:
calculating the second pressure based on a target pressure downstream of the first throttle valve.

6. The control method as claimed in claim 2, wherein the exhaust gas recirculation passage is provided with an exhaust gas recirculation cooler, and wherein the calculation of the first pressure is implemented based on:
the target exhaust gas recirculation gas quantity;
the calculated exhaust pressure;
the temperature of exhaust gas recirculation gas passing through the exhaust gas recirculation valve;
a temperature of exhaust gas passing through the exhaust passage; and
an airflow resistance of the exhaust gas recirculation cooler.

7. The control method as claimed in claim 2, wherein the calculation of the exhaust pressure is implemented based on:
an atmospheric pressure;
a temperature of exhaust gas passing through the exhaust passage;
a passage resistance of the exhaust passage; and
a flow rate of exhaust gas discharged from the exhaust passage to outside.

8. The control method as claimed in claim 7, wherein the temperature of exhaust gas passing through the exhaust passage is sensed using a temperature sensor or estimated using no temperature sensor.

9. The control method as claimed in claim 6, wherein the temperature of exhaust gas recirculation gas passing through the exhaust gas recirculation valve is sensed using a temperature sensor or estimated using no temperature sensor.

10. The control method as claimed in claim 7, wherein the first end of the exhaust gas recirculation passage is connected to a section of the exhaust passage upstream of the exhaust particulate filter, and wherein the flow rate of exhaust gas discharged from the exhaust passage to outside is set to the flow rate of exhaust gas passing through the exhaust particulate filter.

11. The control method as claimed in claim 7, wherein the first end of the exhaust gas recirculation passage is connected to a section of the exhaust passage downstream of the exhaust particulate filter, and wherein the flow rate of exhaust gas discharged from the exhaust passage to outside is set by subtracting the target exhaust gas recirculation gas quantity from the flow rate of exhaust gas passing through the exhaust particulate filter.

12. An exhaust pressure estimation device for an internal combustion engine, comprising:
an exhaust passage provided with an exhaust particulate filter for capturing exhaust particulates; and
a controller configured to calculate an exhaust pressure within the exhaust passage based on a flow rate of exhaust gas passing through the exhaust particulate filter.
